(19) United States
(12) Patent Application Publication
(10) Pub. No.: US 2026/0222514 A1
(43) Pub. Date: Jul. 30, 2026

(54) EFFECT DISPLAY METHOD, DEVICE, AND STORAGE MEDIUM

(71) Applicant: Beijing Zitiao Network Technology Co., Ltd., Haidian District, Beijing (CN)

(72) Inventor: Ruchong LUO, Beijing (CN)

(21) Appl. No.: 19/142,037

(22) PCT Filed: Dec. 8, 2023
(86) PCT No.: PCT/CN2023/137306

§ 371 Date: Jun. 20, 2025

(30) Foreign Application Priority Data
Dec. 22, 2022 (CN) 202211659276.1

(51) Int. Cl. H04N 5/262

(52) U.S. Cl. CPC H04N 5/2625

(57) ABSTRACT

Embodiments of the present disclosure provides an effect display method, a device, and a storage medium. The effect display method includes: displaying a first trailing picture of an effect object at a first motion frame when the effect object is in a motion state, the effect object being a selected object to which a trailing effect is applied; capturing a second motion frame of the effect object at a set frame rate; determining a second trailing picture of the effect object at the second motion frame through the first trailing picture; and displaying the second trailing picture.

This application claims the priority to and benefits of Chinese Patent Application No. 202211659276.1, filed on Dec. 22, 2022, the entire contents of which are incorporated herein by reference.

### TECHNICAL FIELD

Embodiments of the present disclosure relate to the field of an effect display method, an apparatus, a device, and a computer-readable storage medium.

### BACKGROUND

With the development of network technology, visual effects can be enhanced by using effect props in entertainment applications for live broadcast, short video, video production and the like. A trailing effect is one of the effects props, which mainly exhibits that an object to which the effect is applied can present the trailing effect during the movement and an effect that a historical motion trajectory has not dissipated is visually presented.

### SUMMARY

The present disclosure provides an effect display method and apparatus, a device and a storage medium, which effectively reduce the resource allocation pressure of the device and is beneficial to the implementation of a trailing effect.

An embodiment of the present disclosure provides an effect display method, and the method includes:
displaying a first trailing picture of an effect object at a first motion frame when the effect object is in a motion state, the effect object being a selected object to which a trailing effect is applied;
capturing a second motion frame of the effect object at a set frame rate;
determining a second trailing picture of the effect object at the second motion frame through the first trailing picture; and
displaying the second trailing picture.

An embodiment of the present disclosure also provides an effect display apparatus, and the apparatus includes:
a first display module, configured to display a first trailing picture of an effect object at a first motion frame when the effect object is in a motion state, the effect object being a selected object to which a trailing effect is applied;
a motion frame capturing module, configured to capture a second motion frame of the effect object at a set frame rate;
a picture determination module, configured to determine a second trailing picture of the effect object at the second motion frame through the first trailing picture; and
a second display module, configured to display the second trailing picture.

An embodiment of the present disclosure also provides an electronic device, and the device includes:
one or more processors; and
a storage apparatus, configured to store one or more programs, the one or more programs, when executed by the one or more processors, cause the one or more processors to implement the effect display method according to any embodiment of the present disclosure.

An embodiment of the present disclosure also provides a computer-readable storage medium, when the computer programs are executed by a processor, the effect display method according any embodiment of the present disclosure is implemented.

### BRIEF DESCRIPTION OF DRAWINGS

The above and other features, advantages and aspects of the embodiments of the present disclosure will become more apparent with reference to the following detailed description in conjunction with the accompanying drawings. Throughout the accompanying drawings, the same or similar reference numerals represent the same or similar elements. It should be understood that the drawings are schematic and components and elements are not necessarily drawn to scale.

FIG. 1 is a flow diagram of an effect display method provided by an embodiment of the present disclosure;

FIG. 2 is an example diagram of a trailing intensity texture map at a certain motion frame in an effect display method provided by an embodiment of the present disclosure;

FIG. 3 is a flow diagram of another effect display method provided by an embodiment of the present disclosure;

FIG. 4 is a structural schematic diagram of an effect display apparatus provided by an embodiment of the present disclosure; and

FIG. 5 is a structural schematic diagram of an electronic device provided by an embodiment of the present disclosure.

### DETAILED DESCRIPTION

The embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments described herein. Instead, these embodiments are provided for a more thorough and complete understanding of the present disclosure. It should be understood that the drawings and embodiments of the present disclosure are only for exemplary purposes and are not intended to limit the scope of protection of the present disclosure.

It should be understood that the various steps described in the method implementation of the present disclosure can be performed in different orders and/or in parallel. In addition, the method implementation may include additional steps and/or omit the steps shown. The scope of the present disclosure is not limited in this respect.

The term “including” and its variations used herein are open inclusions, i.e., “including but not limited to”. The term “based on” is “based at least in part on”. The term “one embodiment” means “at least one embodiment”; the term “another embodiment” means “at least one other embodiment”; the term “some embodiments” means “at least some embodiments”. The relevant definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modifications of “one” and “multiple” mentioned in this disclosure are illustrative rather than restrictive. Those skilled in the art should understand that unless otherwise clearly stated in the context, they should be understood as “one or more”.

The names of the messages or information exchanged between multiple devices in the embodiments of this disclosure are only for illustrative purposes, and are not used to limit the scope of these messages or information.

It is understood that before using the technical solutions disclosed in each embodiment of this disclosure, the type, scope of use, and usage scenarios of the personal information involved in this disclosure should be informed to the user in an appropriate manner in accordance with relevant laws and regulations and the user's authorization should be obtained.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as an electronic device, an application program, a server or a storage medium that performs the operations of the technical solution of the present disclosure according to the prompt information.

As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose “agree” or “disagree” to provide personal information to the electronic device.

It can be understood that the above process of notifying and acquiring user authorization is only schematic, and does not limit the implementation of the present disclosure, and other ways meeting relevant laws and regulations can also be applied to the implementation of the present disclosure.

It can be understood that the data referred to in this technical solution (including but not limited to the data itself, the acquisition or use of the data) should comply with the requirements of the applicable laws and regulations and related regulations.

In an implementation of some trailing effects, it is necessary to record a motion trajectory of an effect-applied object in each frame. In each current frame, it is necessary to generate one entity for each frame corresponding to a historical motion trajectory, and then to give each entity a different trailing color according to a motion position. For example, for a moving effect-applied object, when an eighth frame acts as a current frame, it needs to generate eight entities to represent effect-applied objects from a first frame to the eighth frame respectively, and then the effect-applied objects in the eight entities are assigned with display states that the effect-applied objects should have in the current frame (the eighth frame) and the display states are displayed.

In the implementation of the trailing effect above, each entity generated needs to occupy a certain amount of computing and storage resources, and with the increase of the motion time of the effect-applied object, a resource occupancy rate of the entity generated by the trailing effect also increases gradually, for example, recording the trailing picture of 20 frames needs resources to be allocated to 20 entities, which greatly increases the pressure on resource allocation of the device and is not conducive to the implementation of the trailing effect.

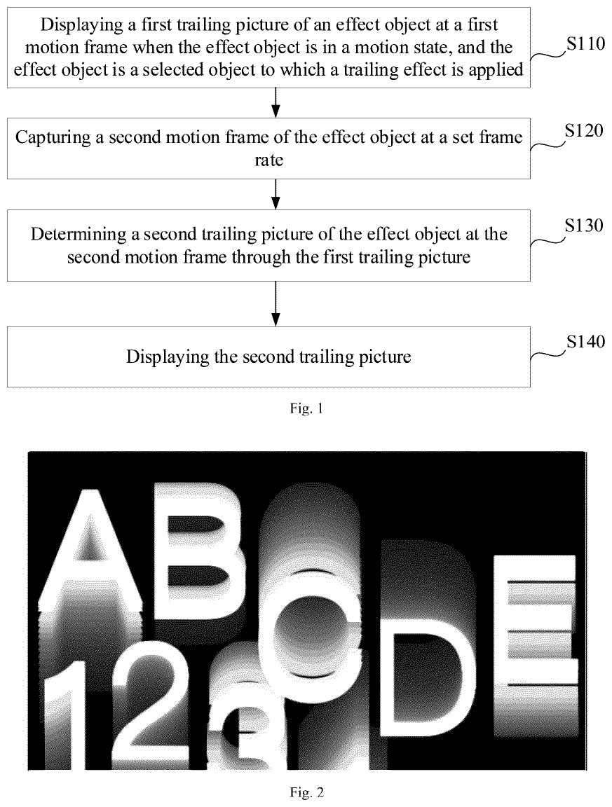

FIG. 1 is a flow diagram of an effect display method provided by an embodiment of the present disclosure. The embodiment of the present disclosure is suitable for a case of achieving the trailing effect. The method can be implemented by an effect display apparatus, which apparatus can be implemented in the form of software and/or hardware, or alternatively, by an electronic device, which can be a mobile terminal, a PC terminal or a server.

As shown in FIG. 1, the method of the embodiment of the present disclosure may specifically include:

S110: displaying a first trailing picture of an effect object at a first motion frame when the effect object is in a motion state, and the effect object is a selected object to which a trailing effect is applied.

It can be clearly seen that in entertainment applications for live streaming, short videos, video production and the like, visual effects can be enhanced by using effects props. A trailing effect is one of the effects props, which mainly exhibits that an object to which the effect is applied can present the trailing effect during the movement and an effect that a historical motion trajectory has not dissipated is visually presented.

The effect object can be specifically understood as a selected object in a trailing effect picture to which the trailing effect is applied. Exemplarily, if a three-dimensional wordart in a slide show is displayed in motion with the trailing effect, the three-dimensional wordart can be considered as an effect object. For another example, if a character in a video display picture is displayed in motion with the trailing effect, the character can be considered as an effect object. It should be noted that in the embodiment of the present disclosure, the effect object is not specifically limited, and it can also be understood that a specific content presented by the trailing picture is not specifically limited. As long as a user wants to display the trailing effect, the user can take the content that will form the trailing effect as the effect object.

Before a trailing effect display operation, the method may also include: receiving a triggering operation of the trailing effect. There are many ways to trigger the triggering operation of the trailing effect. Optionally, the receiving the triggering operation of the effect may include, but is not limited to: receiving an effect triggering operation acting on a preset effect triggering control, the effect triggering control may be a control element disposed on a display interface, for example, the control element at least includes at least one of an effect triggering button, an effect triggering selection menu and an effect triggering slider; or, receiving sound information for starting effects based on a sound acquisition apparatus; or, receiving an effect start command for starting an effect, etc.

In the embodiment of the present disclosure, when the effect object is in a motion state, the trailing pictures of the effect object are different at different motion frames, and the motion trajectory of the effect object is displayed as the trailing pictures to achieve the trailing effect. Under different motion frames, the trailing picture may differ in a change in a position of the effect object, a change in a presented color of the whole effect object and a change in a length of the trailing picture. In order to distinguish the effect object in the motion state, in this embodiment, two adjacent motion frames are recorded as a first motion frame and a second motion frame respectively, the first motion frame may be an initial motion frame or may refer to any of motion frames in the motion state, and a next motion frame of the first motion frame is recorded as the second motion frame. The trailing picture at the first motion frame is recorded as a first trailing picture, and the trailing picture at the second motion frame is recorded as a second trailing picture.

It should be noted that, different from some situations where each frame corresponding to the historical motion trajectory needs to generate one entity when generating the trailing effect, in this embodiment, only one entity needs to be generated, and when the motion trajectory is the initial motion frame, the corresponding entity is generated, and the effect object is preliminarily rendered to generate an initial trailing intensity texture map. Specifically, when the trailing effect is started, the effect object is rendered, and attribute display information of the effect object is baked into a texture map, which may include information such as a display transparency, but not include color information. When the picture of the initial motion frame is generated, the subsequent trailing effect is generated based on the previous trailing map. In this way, it is not necessary to generate one entity for each frame, saving memory resources.

It can be understood that the first trailing picture is determined based on the intensity texture map, and in this embodiment, the intensity texture map corresponding to the first trailing picture is recorded as a first intensity texture map. After the first intensity texture map is acquired, the first intensity texture map is colored to obtain the first trailing picture. Before coloring the first intensity texture map, it is necessary to determine which color is to be used for coloring the intensity texture map. The color can be determined by acquiring a preset corresponding relationship between intensity values and colors. There is a one-to-one correspondence between intensities and colors. When the intensity is known, the color corresponding to the intensity can be determined by acquiring the preset corresponding relationship between intensity values and colors. The first intensity texture map is colored with the determined color to finally obtain the first trailing picture.

In this embodiment, regarding the first intensity texture map of the first trailing picture, there is a difference in a generation method of the first intensity texture map in terms of whether it is the initial motion frame. When the first intensity texture map is the initial motion frame, the generation method of the first intensity texture may be as follows: acquiring first display attribute information of the effect object after rendered in the initial motion frame; and generating a first attribute texture map of the effect object as a first trailing intensity texture map based on the first display attribute information. When the first intensity texture is not the initial motion frame, the generation method of the first intensity texture map may be as follows: acquiring a trailing intensity texture map in a trailing picture in a previous frame, and then in combination with an attenuation factor, determining a first trailing intensity texture map of the effect object in the first motion frame.

Specifically, when the effect object is in a motion state, the first trailing picture of the effect object at the first motion frame is displayed on a display interface. If the first motion frame is the initial motion frame, the first trailing picture refers to a picture displaying an original image. If the first motion frame is not the initial motion frame, it means that the effect object has moved and produced a motion trajectory, and the content displayed in the first trailing picture contains an effect that the trailing processing has been performed on the effect object.

S120: capturing a second motion frame of the effect object at a set frame rate.

The second motion frame is relative to the first motion frame, and the second motion frame can be understood as a next frame of the first motion frame. When comparing the second motion frame with the first motion frame, a specific content displayed by the second motion frame has not changed, but a position and a trailing situation of the content have changed. The frame rate is a frequency at which images in units of frames appear continuously on the display interface, and the set frame rate can be set based on historical experience data. In this embodiment, because there is only one entity in the implementation of the effect in this embodiment, it can also be understood that only one original picture is used to achieve the trailing effect. In order to form a trailing picture at the next motion frame, it is necessary to capture the second motion frame of the effect object in addition to processing the acquired first trailing picture. Specifically, by capturing the second motion frame of the effect object at a set frame rate, information of a position to which the effect object moves to at the second motion frame can be acquired. Exemplarily, taking a three-dimensional wordart in a video as an example, if the three-dimensional wordart in the video is displayed in motion with the trailing effect, the three-dimensional wordart can be considered as an effect object. When the effect object is the motion state, the first trailing picture of the effect object at the first motion frame will be displayed in the video picture. In order to determine the second trailing picture at the second motion frame, it is necessary to acquire relevant information of the second motion frame, that is, a specific presentation position of the three-dimensional wordart in the video at the second motion frame, and other information.

S130: determining a second trailing picture of the effect object at the second motion frame through the first trailing picture.

It can be understood that if no trailing effect is applied, the first picture presented by the effect object at the first motion frame and the second picture presented at the second motion frame only show that the position of the effect object has changed and the effect object has moved. However, after the trailing effect is applied, the first trailing picture presented by the effect object at the first motion frame and the second trailing picture presented at the second motion frame will display corresponding trailing effects, and the trailing effects display a motion trajectory of the effect object accordingly. Different from a situation where each frame corresponds to one entity, in this embodiment, when generating the trailing picture of the next motion frame, the trailing picture is generated based on the historical trailing picture and the second motion frame.

In the embodiment of the present disclosure, in order to easily describe how the trailing picture is formed at each motion frame, two adjacent motion frames are recorded as the first motion frame and the second motion frame respectively, the first motion frame and the second motion frame are only used to indicate a time sequence of motion frames. Similarly, the trailing picture at the first motion frame is recorded as a first trailing picture, and the trailing picture at the second motion frame is recorded as a second trailing picture. The first trailing picture and the second trailing picture are only used to indicate the sequence of display of the trailing pictures; in other words, the effect object will form different trailing pictures at different motion frames, to provide the user with the effect of displaying the motion trajectory of the effect object.

In the embodiment of the present disclosure, the display effect of the trailing picture is that the original image of the effect object is displayed first, and the trailing image characterizing the previous trajectory of the effect object needs to be displayed with corresponding attenuation of the display transparency, so as to achieve an effect that the motion trajectory of the effect object gradually becomes shallow and finally disappears. In order to achieve the gradual decrease of the display transparency of the image, correlation operations can be performed based on an attenuation factor that is predetermined.

It can be understood that the first trailing picture is determined based on the trailing intensity texture map, and the first trailing picture of the effect object at the first motion frame is obtained by coloring the trailing intensity texture map. Similarly, in this embodiment, the second trailing picture is also determined based on the trailing intensity texture map, and the second trailing picture of the effect object at the second motion frame is obtained by coloring the trailing intensity texture map. In order to determine the second trailing intensity texture map corresponding to the second trailing picture, determination may be made based on the first trailing intensity texture in combination with the attenuation factor. Therefore, in this embodiment, when determining the second intensity texture map, it is necessary to first extract the first intensity texture map from the first trailing picture.

Meanwhile, the attenuation factor corresponding to the second motion frame can be determined. A trailing attenuation texture map can be obtained by multiplying the trailing intensity value corresponding to each pixel point in the first trailing intensity texture map and the attenuation factor. In addition, a motion picture frame at the second motion frame can be obtained. The second trailing picture can be determined based on the motion picture frame and the trailing attenuation texture map at the second motion frame. The way to determine the second trailing picture based on the motion picture frame and the trailing attenuation texture map at the second motion frame can be as follows: obtaining the attribute texture map of the motion picture frame at the second motion frame, performing a merge process on the attribute texture map and the trailing attenuation texture map, and taking a merged texture map as the second trailing intensity texture map at the second motion frame. After the second trailing intensity texture map is obtained, the trailing picture of the effect object at the second motion frame is obtained by coloring the second trailing intensity texture map. When coloring the second trailing intensity texture map, it is necessary to determine the color corresponding to the intensity value of each pixel point in the texture map according to the preset corresponding relationship between intensity values and colors, and then color the corresponding pixel point with the determined color.

It should be clear that the intensity of the current frame is co-determined by the historical frame and the attenuation factor. A process of forming the trailing picture provided by this embodiment is an iteration process, that is, in a next iteration, the second motion frame can be regarded as a first motion frame, and then a new second motion frame can be re-captured, and the determination of the second trailing picture can be repeated. With the playing of the motion frames, the effect object moves, so that it is necessary to constantly determine the current trailing picture at the current motion frame and display it. It can be understood that in this step, the way to generate the trailing picture of the next motion frame is determined based on the trailing picture of the historical frame and the attenuation factor. In other words, different from a situation where one entity is generated for each frame and each entity image is processed and then merged in some implementations of trailing effects, in this embodiment, only one entity is needed, and the determination of the trailing picture of the next frame only needs the entity image, the trailing picture of the historical frame and the attenuation factor, so that the occupation of memory resources is reduced and the trailing effect is good.

S140: displaying the second trailing picture.

Specifically, after the second trailing picture is generated, the second trailing picture is displayed in the display interface. Exemplarily, in a scene where the three-dimensional wordart in the slide show is displayed in motion with the trailing effect, the running of the trailing effect of the three-dimensional wordart can be formed by determining the trailing pictures at various motion frames. For another example, if a character in a video display picture is displayed in motion with the trailing effect, the trailing picture at each motion frame can be determined, and the motion of a task trailing effect can be formed.

For example, FIG. 2 is an example diagram of a trailing intensity texture map at a certain motion frame in an effect display method provided by an embodiment of the present disclosure. As shown in FIG. 2, it can be seen that the effect objects are text ABC, etc. The intensity of the top-layer text facing the user is the highest, and the intensity of the lower-layer text decreases gradually. As the number of layers increases, the corresponding intensity decreases. For different intensities, the text can be colored in different colors for evident distinction. For example, if the uppermost layer is displayed as white, its intensity gradually decreases with the number of layers increasing from top to bottom, and the layers can be sequentially colored with yellow, red, purple, blue and so on. Images of the same layer may be colored differently due to different intensities. Adjacent layers can also be colored with a gradient color, thus providing the user with a vivid visual effect. Further, with the sequential playing of each motion frame, the effect that the effect object which moves has a trailing can be formed, and the visual effect that the effect object moves along the motion trajectory can be generated.

An embodiment of the present disclosure provides an effect display method, including: displaying a first trailing picture of an effect object at a first motion frame when the effect object is in a motion state, the effect object is a selected object to which a trailing effect is applied; capturing a second motion frame of the effect object at a set frame rate; determining a second trailing picture of the effect object at the second motion frame through the first trailing picture; and displaying the second trailing picture. According to the technical solution of the embodiment of the present disclosure, when determining the second trailing picture, the trailing picture of the effect object at the current motion frame can be determined through the historical trailing picture based on a historical result first trailing picture of the previous frame. Different from some implementations of a trailing effect, a trailing picture in the current motion frame is simplified to be determined on the basis of a historical result of the previous frame, an implementation process of the trailing effect only requires one entity, and there is no need to generate an entity for each frame in a historical trajectory, such that the technical problem of high resource allocation pressure caused by the need to generate an entity for each frame during the implementation of some trailing effects is solved, and the resource allocation pressure of a device is effectively reduced while the trailing effect is ensured, thereby facilitating the implementation of the trailing effect.

As an optional embodiment of the embodiment of the present disclosure, on the basis of the above embodiment, it is further optimized that after displaying the second trailing picture, the method further includes: taking the second motion frame as a new first motion frame and the second trailing picture as a new first trailing picture, and returning to continue a capturing operation for obtaining a second motion frame.

A process of forming the trailing picture provided by this embodiment is an iteration process, that is, in a next iteration, the second motion frame can be regarded as a new first motion frame and the second trailing picture can be regarded as a new first trailing picture, and then a new second motion frame can be re-captured, and the determination of the second trailing picture can be repeated. With the playing of the motion frames, the effect object moves, so that it is necessary to constantly determine the current trailing picture at the current motion frame and display it.

It can be understood that in this step, the way to generate the trailing picture of the next motion frame is determined based on the trailing picture of the historical frame and the attenuation factor. In other words, different from a situation where one entity is generated for each frame and each entity image is processed and then merged in some implementations of trailing effects, in this embodiment, only one entity is needed, and the determination of the trailing picture of the next frame only needs the entity image, the trailing picture of the historical frame and the attenuation factor, so that the occupation of memory resources is reduced and the trailing effect is good.

As an optional embodiment of the embodiment of the present disclosure, on the basis of the above embodiment, it is further optimized that when the first motion frame is the initial motion frame, the step of determining the first trailing picture includes:

a1: acquiring first display attribute information of the effect object after rendered in the initial motion frame.

In the embodiment of the present disclosure, for the initial motion frame, what picture is to be presented, what effect object is contained in the picture, and what the display transparency corresponding to the effect object is can be known. That is to say, there is a prediction for the first motion frame for trailing effect display. Based on this prediction, it can be extracted that in order to achieve this prediction, it is necessary to first clarify what the effect object is, and after determining the effect object, it can be determined what kind of display attribute information the effect object wants to display.

The display attribute information may be display brightness, display gray scale or the display transparency. For example, the display attribute information in this embodiment is the display transparency, which is equivalent to the intensity. The effect object is rendered at the initial motion frame through predetermined rendering information, and after rendering, display attribute information of the effect object rendered at the initial motion frame can be obtained, and this display attribute information is recorded as first display attribute information in this step. Exemplarily, a human-computer interaction interface can be provided for relevant technicians to set the first display attribute information on the interaction interface. When the technician selects relevant attribute information, the selected attribute information will be used as a display attribute for generating the first trailing intensity texture map.

b1: generating a first attribute texture map of the effect object as a first trailing intensity texture map based on the first display attribute information.

In the embodiment of the present disclosure, if the first motion frame is an initial motion frame, one entity is generated to represent the initial motion frame. The effect object in this entity is preliminarily rendered to obtain a trailing intensity texture map, which is recorded as the first trailing intensity texture map of the effect object in the initial motion frame in this embodiment. The way of rendering the effect object is a baking technology, which bakes the display attribute information of the effect object into a texture map. Illustratively, the display attribute information may be the display transparency. It can be understood that the display attribute of the effect object in the first trailing intensity texture map at the initial motion frame is not attenuated, in other words, the initial trailing intensity texture map is an original intensity texture map about the effect object and has not been colored.

In the embodiment of the present disclosure, rendering is performed at the initial motion frame, and the effect object is generated after being rendered. Then, the display attribute information of the rendered effect object is baked based on the baking technology, and the effect object is baked into a texture map as a trailing intensity texture map. It can be understood that the baking technology is equivalent to dividing an image where the effect object is located into grids, and baking is completed for each independent grid, thus determining the first trailing intensity texture map.

In the embodiment of the present disclosure, after first display information of the effect object rendered at the initial motion frame is acquired, baking is performed based on the first display attribute information to generate the first attribute texture map of the effect object as the first trailing intensity texture map. For example, the first attribute information is the display transparency, and it can be understood that the trailing intensity texture map corresponding to the initial motion frame has the intensity of the original image.

c1: coloring the first trailing intensity texture map to obtain the first trailing picture of the effect object.

In this step, after the first trailing intensity texture map is acquired, the trailing effect can be seen in the display effect, but in order to make the trailing effect more obvious visually, it can be colored according to the intensity corresponding to the first trailing intensity texture map. Specifically, a color data value corresponding to the first trailing intensity value in the first trailing intensity texture map can be determined according to the preset corresponding relationship between intensity values and colors. The pixel point is colored with the color data value to obtain the first trailing picture of the effect object at the initial motion frame.

According to the technical solution, the generation step of the first trailing picture at the initial motion frame is refined, including: first generating the first trailing intensity texture map of the effect object in the first motion frame, and then coloring the first trailing intensity texture map to obtain the first trailing picture of the effect object. Based on the first trailing picture, the trailing picture of the subsequent motion frame can be determined, so that memory resources are saved and the cost is reduced.

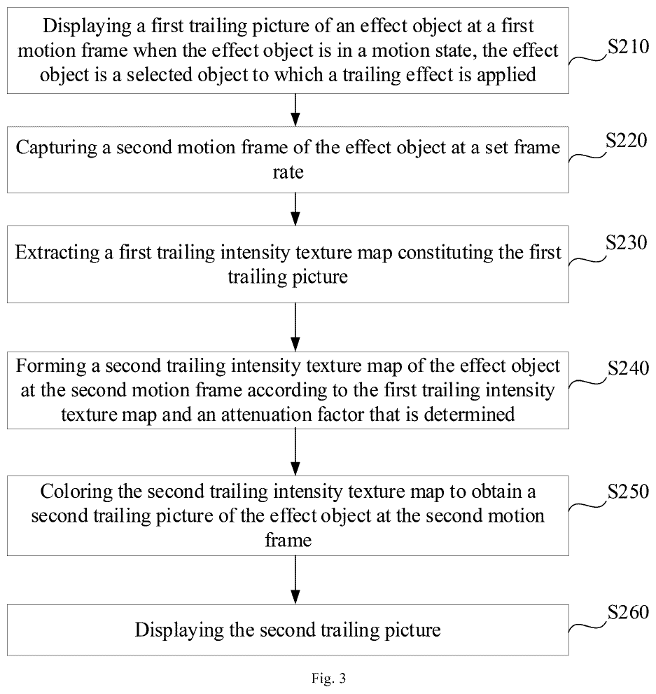

FIG. 3 is a flow diagram of another effect display method provided by an embodiment of the present disclosure. The embodiment of the present disclosure further explains the step of determining a second trailing picture of the effect object at the second motion frame through the first trailing picture. As shown in FIG. 3, the method includes:
S210: displaying a first trailing picture of an effect object at a first motion frame when the effect object is in a motion state, the effect object is a selected object to which a trailing effect is applied.
S220: capturing a second motion frame of the effect object at a set frame rate.
S230: extracting a first trailing intensity texture map constituting the first trailing picture.

In the embodiment of the present disclosure, the second motion frame can be understood as a next frame of the first motion frame, and the second motion frame is relative to the first motion frame. In this embodiment, only one entity is generated, and pictures of subsequent frames can be generated based on pictures of historical frames. The second motion frame can be regarded as a current motion frame and the first motion frame can be regarded as a historical motion frame. In order to determine the trailing picture of the current motion frame, it is necessary to first determine a trailing intensity texture map of the current motion frame, and then color the trailing intensity texture map to obtain a trailing picture at the current motion frame, that is, to obtain a second trailing picture at the second motion frame.

It should be clear that the trailing intensity texture map of the current motion frame needs to be determined based on the trailing intensity texture map of the historical frame. This step is used to acquire the trailing intensity texture map of the historical frame and extract the first trailing intensity texture map constituting the first trailing picture.

S240: forming a second trailing intensity texture map of the effect object at the second motion frame according to the first trailing intensity texture map and an attenuation factor that is determined.

The attenuation factor is an attenuation coefficient of the current motion frame relative to the historical frame intensity. For example, the attenuation factor can be any value between 0 and 1. For example, the attenuation factor is a set constant; or, the attenuation factor is determined according to a duration of motion of the effect object in the motion state. If the attenuation factor is set to a set constant, it can be understood that an attenuation degree of the intensity of each current motion frame relative to the previous historical motion frame is the same. If the attenuation factor is determined according to the duration of motion of the effect object in the motion state, for example, if the attenuation factor gradually decreases with the increase of the motion duration, it can be understood that the attenuation factor gradually decreases with the increase of the duration of motion, and the attenuation degree is getting smaller and smaller. It can be understood that the trailing length is determined by the attenuation factor. The larger the attenuation factor is, the faster the trailing attenuation is and the shorter the trailing length is. The smaller the attenuation factor is, the slower the trailing attenuation is and the longer the trailing length is.

This step is used for forming a second trailing intensity texture map of the effect object at the second motion frame according to the first trailing intensity texture map and an attenuation factor that is determined. Specifically, the trailing attenuation texture map is obtained based on the first trailing intensity texture map and the attenuation factor corresponding to the second motion frame. After obtaining the trailing attenuation texture map, in order to obtain the second trailing intensity texture map of the effect object at the second motion frame, it is necessary to merge the attribute texture map corresponding to the motion picture frame at the second motion frame, so that the second trailing intensity texture map can be determined by merging the trailing attenuation texture map and the attribute texture map. The attribute texture map corresponding to the motion picture frame at the second motion frame can generate the second attribute texture map of the effect object based on second display attribute information of the effect object rendered at the second motion frame.

Further, the forming a second trailing intensity texture map of the effect object at the second motion frame according to the first trailing intensity texture map and a determined attenuation factor includes:

a2: obtaining a trailing attenuation texture map based on the first trailing intensity texture map and the attenuation factor corresponding to the second motion frame.

Specifically, based on the attenuation factor corresponding to the second motion frame, the intensity value of each pixel point of the first trailing intensity texture map is attenuated to obtain a trailing attenuation texture map.

Further, the obtaining a trailing attenuation texture map based on the first trailing intensity texture map and the attenuation factor corresponding to the second motion frame includes:

a21: obtaining a corresponding target attenuation factor at the second motion frame.

It can be known that each motion frame has a corresponding attenuation factor, which can be a preset constant or related to the duration of motion of the effect object. For each motion frame, the attenuation factor corresponding to the frame can be obtained as a known quantity. Specifically, the corresponding attenuation factor at the second motion frame is acquired and recorded as the target attenuation factor.

a22: multiplying a first trailing intensity value of each pixel point in the first trailing intensity texture map and the target attenuation factor to obtain the trailing attenuation texture map.

The trailing attenuation texture map can be understood as a part of trailing attenuation in the second intensity texture map at the second motion frame. The first trailing intensity texture map consists of pixel points, each pixel point corresponding to a trailing intensity value. By multiplying the first intensity value of each pixel point in the first trailing intensity texture map and the target attenuation factor, the corresponding intensity value of each pixel point after attenuation is obtained, thus forming the trailing attenuation texture map.

The technical solution above embodies how to obtain the trailing attenuation texture map based on the historical trailing intensity texture map and the attenuation factor corresponding to the current motion frame, thus providing a basis for determining the current intensity texture map.

b2: obtaining a second motion picture frame of the effect object at the second motion frame.

Specifically, the motion picture frame of the effect object at the second motion frame is obtained and recorded as the second motion picture frame.

c2: forming a second trailing intensity texture map of the effect object at the second motion frame, according to the second motion picture frame and the trailing attenuation texture map.

In this step, according to the obtained second motion picture frame, the second attribute texture map of the effect object with a display attribute relatively set at the second motion picture frame is obtained, the second attribute texture map and the trailing attenuation map are merged, and a merging result is taken as the second trailing intensity texture map. The generation principles of the second attribute texture map and the first attribute texture map are the same.

The technical solution above details how to form the current trailing intensity texture map of the effect object at the current motion frame according to the historical trailing intensity texture map and the attenuation factor, thus providing a basis for generating the current trailing picture at the current motion frame. Different from some situations where one entity needs to be generated for each frame in a historical motion trajectory, this technical solution only needs to generate one entity, and the trailing intensity texture map of the current frame can be determined based on the trailing intensity texture map of the historical frame and the attenuation factor, thus reducing the occupation of memory resources and saving the cost.

Further, the forming a second trailing intensity texture map of the effect object at the second motion frame, according to the second motion picture frame and the trailing attenuation texture map includes:

c21: obtaining a second attribute texture map, relative to a set display attribute, of the effect object at the second motion picture frame.

Specifically, the second display attribute information of the effect object after being rendered at the second motion frame is acquired, and based on the second attribute value of the set display attribute in the second display attribute information, the second attribute texture map of the effect object is generated.

c22: performing a merge process on the second attribute texture map and the trailing attenuation texture map.

Specifically, the second attribute texture map and the trailing attenuation texture map are merged.

c23: taking a merged texture map as the second trailing intensity texture map of the effect object at the second motion frame.

Specifically, the merged texture map is taken as the second trailing intensity texture map of the effect object at the second motion frame.

According to the technical solution above, how to form the current trailing intensity texture map of the effect object at the current motion frame according to the current motion picture frame and the trailing attenuation texture map is embodied. This technical solution only needs to generate one entity, and the trailing intensity texture map of the current frame can be determined based on the trailing intensity texture map and the trailing attenuation texture map of the historical frame, thus reducing the occupation of memory resources and saving the cost.

S250: coloring the second trailing intensity texture map to obtain a second trailing picture of the effect object at the second motion frame.

Specifically, each pixel point in the second trailing intensity texture map corresponds to one trailing intensity value, and the corresponding relationship between intensities and colors can be set in advance; according to the trailing intensity value of each pixel point, combined with the corresponding relationship, the color corresponding to each pixel can be determined, and the second trailing intensity texture map is colored based on the corresponding color to obtain the second trailing picture at the second motion frame.

Further, the coloring the second trailing intensity texture map to obtain a second trailing picture of the effect object at the second motion frame includes:

a3: obtaining a second trailing intensity value of each pixel point in the second trailing intensity texture map.

Specifically, each pixel point in the second trailing intensity texture map corresponds to one trailing intensity value. The trailing intensity value of each pixel point in the second trailing intensity texture map is obtained, and recorded as the second trailing intensity value.

b3: determining a color data value corresponding to the second trailing intensity value according to a preset corresponding relationship between intensity values and colors.

The corresponding relationship between intensity values and colors is preset. When the intensity value is known, the color corresponding to the intensity value can be determined by querying the corresponding relationship between intensity values and colors. Exemplarily, assuming that intensity values include an intensity 1, an intensity 2, an intensity 3 and the like, and colors include a color value 1, a color value 2, a color value 3 and the like, the intensity values can be associated and bound with the colors in advance; for example, the intensity 1 corresponds to the color value 1, the intensity 2 corresponds to the color value 2 and the intensity 3 corresponds to the color value 3; if it is determined that a second trailing intensity value is the intensity 2, it is determined that the color value corresponding to the second trailing intensity value is the color value 2 by querying the preset corresponding relationship between intensity values and colors.

c3: coloring the pixel point with the color data value to obtain the second trailing picture of the effect object at the second motion frame.

Specifically, each pixel point in the second intensity texture map is colored based on the determined color data value, to obtain the trailing picture of the effect object at the second motion frame, which is recorded as the second trailing picture.

The technical solution embodies how to color the trailing intensity texture map to obtain the second trailing picture of the effect object, and by coloring, the trailing picture has various remarkable visual effects.

S260: displaying the second trailing picture.

According to the technical solution above, when the effect object is in a motion state, the historical trailing intensity texture map can be extracted through the historical trailing picture of the effect object at the historical motion frame, and the current trailing intensity texture map of the effect object at the current motion frame can be determined in combination with the attenuation factor, and the current trailing intensity texture map is colored, so that the current trailing picture at the current motion frame can be obtained. When determining the next trailing picture at the next motion frame, it can be carried out by taking the current motion frame as the historical motion frame and the current trailing picture as the historical trailing picture, and continuing to determine the next trailing picture, thereby repeating an iteration process and implementing the determination of the trailing picture. By using this method, an implementation process of the trailing effect only requires one entity, and there is no need to generate a corresponding entity for each frame in the historical motion trajectory, such that the resource allocation pressure of a device is effectively reduced while the trailing effect is ensured, thereby facilitating the implementation of the trailing effect. At the same time, the attenuation factor is utilized to make the intensity attenuation of the trailing intensity texture map more regular, so that the color is gradual after coloring and the visual presentation effect is better.

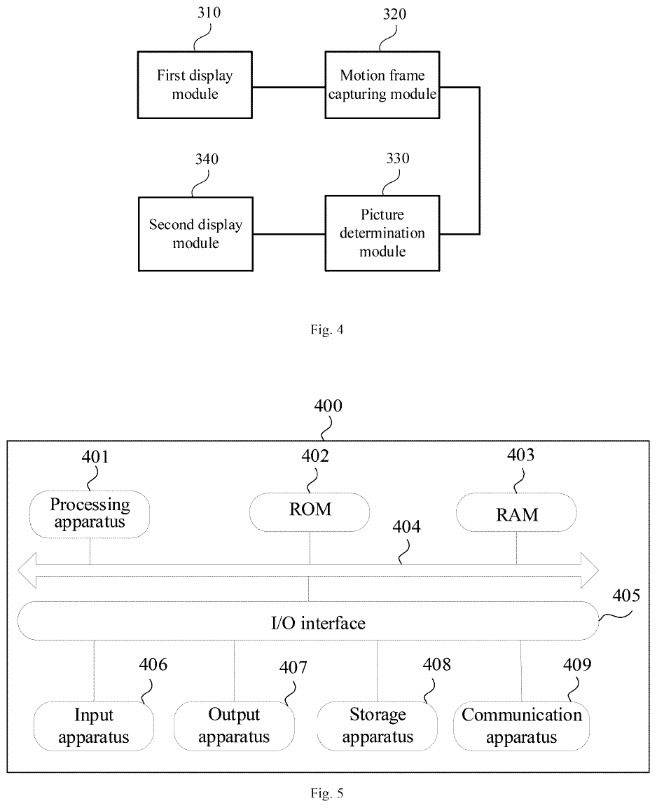

FIG. 4 is a schematic structural diagram of an effect display apparatus provided by an embodiment of the present disclosure. As shown in FIG. 4, the apparatus includes: a first display module 310, a motion frame capturing module 320, a picture determination module 330, and a second display module 340.

The first display module 310 is configured to display a first trailing picture of an effect object at a first motion frame when the effect object is in a motion state, where the effect object is a selected object to which a trailing effect is applied; the motion frame capturing module 320 is configured to capture a second motion frame of the effect object at a set frame rate; the picture determination module 330 is configured to determine a second trailing picture of the effect object at the second motion frame through the first trailing picture; and the second display module 340 is configured to display the second trailing picture.

According to the technical solution of the embodiment of the present disclosure, the following steps are included: displaying a first trailing picture of an effect object at a first motion frame when the effect object is in a motion state, where the effect object is a selected object to which a trailing effect is applied; capturing a second motion frame of the effect object at a set frame rate; determining a second trailing picture of the effect object at the second motion frame through the first trailing picture; and displaying the second trailing picture. According to the technical solution of the embodiment of the present disclosure, when determining the second trailing picture, the trailing picture of the effect object at the current motion frame can be determined through the historical trailing picture based on a historical result first trailing picture of the previous frame. Different from some implementations of a trailing effect, a trailing picture in the current motion frame is simplified to be determined on the basis of a historical result of the previous frame, an implementation process of the trailing effect only requires one entity, and there is no need to generate a corresponding entity for each frame, such that the technical problem of high resource allocation pressure caused by the need to generate an entity for each frame in a historical motion trajectory during the implementation of some trailing effects is solved, and the resource allocation pressure of a device is effectively reduced while the trailing effect is ensured, thereby facilitating the implementation of the trailing effect.

Optionally, the apparatus further includes an updating module, which, after the second trailing picture is displayed, is specifically configured to:
take the second motion frame as a new first motion frame and the second trailing picture as a new first trailing picture, and return to continue a capturing operation for obtaining a second motion frame.

Optionally, the apparatus further includes a first trailing picture determination module, and when the first motion frame is an initial motion frame, the first trailing picture determination module is specifically configured to:
acquire first display attribute information of the effect object after rendered in the initial motion frame;
generate a first attribute texture map of the effect object as a first trailing intensity texture map based on the first display attribute information; and
color the first trailing intensity texture map to obtain the first trailing picture of the effect object.

Optionally, the picture determination module 330 may include:
a first extraction unit, configured to extract the first trailing intensity texture map constituting the first trailing picture;
a second texture determination unit, configured to form a second trailing intensity texture map of the effect object at the second motion frame according to the first trailing intensity texture map and an attenuation factor that is determined; and
a second picture generating unit, configured to color the second trailing intensity texture map to obtain a second trailing picture of the effect object at the second motion frame.

Optionally, the attenuation factor is a set constant; or, the attenuation factor is determined according to a duration for which the effect object has moved in the motion state.

Optionally, the second texture determination unit is specifically configured to:
obtain a trailing attenuation texture map based on the first trailing intensity texture map and the attenuation factor corresponding to the second motion frame;
obtain a second motion picture frame of the effect object at the second motion frame; and
form a second trailing intensity texture map of the effect object at the second motion frame according to the second motion picture frame and the trailing attenuation texture map.

Optionally, the second texture determination unit is configured to perform the step of obtaining a trailing attenuation texture map based on the first trailing intensity texture map and the attenuation factor corresponding to the second motion frame, including:
obtaining a corresponding target attenuation factor at the second motion frame; and
multiplying a first trailing intensity value of each pixel point in the first trailing intensity texture map and the target attenuation factor to obtain the trailing attenuation texture map.

Optionally, the second texture determination unit is configured to perform the step of forming a second trailing intensity texture map of the effect object at the second motion frame according to the second motion picture frame and the trailing attenuation texture map, including:
obtaining a second attribute texture map, relative to a set display attribute, of the effect object at the second motion picture frame;
performing a merge process on the second attribute texture map and the trailing attenuation texture map; and
taking a merged texture map as the second trailing intensity texture map of the effect object at the second motion frame.

Optionally, the picture determination module 330 is specifically configured to:
obtain a second trailing intensity value of each pixel point in the second trailing intensity texture map;
determine a color data value corresponding to the second trailing intensity value according to a preset corresponding relationship between intensity values and colors; and
color the pixel point with the color data value to obtain the second trailing picture of the effect object at the second motion frame.

The effect display apparatus provided by the embodiment of the present disclosure can execute the effect display method provided by any embodiment of the present disclosure, and has corresponding functional modules for executing the method and beneficial effects.

It is worth noting that the various units and modules included in the above apparatus are only divided according to functional logics, but not limited thereto, as long as the corresponding functions can be implemented; in addition, the specific names of the functional units are only for the convenience of distinguishing between each other, and are not used to limit the protection scope of the embodiments of the present disclosure.

FIG. 5 is a structural schematic diagram of an electronic device provided by an embodiment of the present disclosure. Reference is now made to FIG. 5, which shows a structural schematic diagram of an electronic device (for example, a terminal device or a server in FIG. 5) 400 suitable for implementing an embodiment of the present disclosure. The terminal devices in the embodiments of the present disclosure may include, but not limited to, mobile terminals such as a mobile phone, a notebook computer, a digital broadcast receiver, a personal digital assistant (PDA), a tablet computer (PAD), a portable multimedia player (PMP), a vehicle-mounted terminal (for example, a vehicle-mounted navigation terminal) and the like, and fixed terminals such as a digital TV, a desktop computer and the like. The electronic device shown in FIG. 5 is only an example, and should not bring any limitation to the functions and application scope of the embodiments of the present disclosure.

As shown in FIG. 5, the electronic device 400 may include a processing apparatus (for example, a central processing unit, a graphics processing unit, etc.) 401, which may perform various appropriate actions and processes according to programs stored in a read-only memory (ROM) 402 or programs loaded from a storage apparatus 408 into a random access memory (RAM) 403. In the RAM 403, various programs and data required for operations of the electronic device 400 are also stored. The processing apparatus 401, the ROM 402 and the RAM 403 are connected to each other through a bus 404. An editing/output (I/O) interface 405 is also connected to the bus 404.

Generally, the following apparatuses may be connected to the I/O interface 405: an input apparatus 404 including, for example, a touch screen, a touch pad, a keyboard, a mouse, a camera, a microphone, an accelerometer, a gyroscope, etc. ; an output apparatus 407 including, for example, a liquid crystal display (LCD), a speaker, a vibrator, etc. ; a storage apparatus 408 including, for example, a magnetic tape, a hard disk, etc. ; and a communication apparatus 409. The communication apparatus 409 may allow the electronic device 400 to perform wireless or wired communication with other devices to exchange data. While the electronic device 400 with various apparatuses is shown in the FIG. 5, it should be understood that it is not required to implement or have all the apparatuses shown. More or fewer apparatuses may alternatively be implemented or provided.

In particular, according to the embodiments of the present disclosure, processes described above with reference to the flowchart may be implemented as a computer software program. For example, an embodiment of the present disclosure includes a computer program product, which includes a computer program carried on a non-transitory computer-readable medium, the computer program including program codes for performing the method shown in the flowchart. In such an embodiment, the computer program may be downloaded and installed from a network through the communication apparatus 409, or installed from the storage apparatus 408, or installed from the ROM 402. When the computer program is executed by the processing apparatus 401, the above functions defined in the method of the embodiments of the present disclosure are performed.

The names of messages or information exchanged between apparatuses in the embodiments of the present disclosure are for illustrative purposes only, and are not intended to limit the scope of the messages or information.

The electronic device provided by the embodiment of the present disclosure belongs to the same inventive concept as the effect display method provided by the embodiment above, technical details that are not described in detail in the present embodiment can be referred to the embodiments above, and the present embodiment has the same advantageous effects as the embodiments above.

An embodiment of the present disclosure provides a computer storage medium having stored thereon a computer programs, which, when executed by a processor, implements the effect display method provided in the embodiments above.

It should be noted that the computer-readable medium mentioned above in the present disclosure may be a computer-readable signal medium or a computer-readable storage medium or any combination of both. The computer-readable storage medium may be, for example, but not limited to, an electrical, magnetic, optical, electromagnetic, infrared, or semiconductor system, apparatus or device, or a combination of any of the above. More specific examples of the computer-readable storage medium may include, but not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program, which program may be used by or in combination with an instruction execution system, apparatus or device. In the present disclosure, the computer-readable signal medium may include a data signal propagated in a baseband or as part of a carrier wave, in which computer-readable program codes are carried. This propagated data signal may take multiple forms, including but not limited to electromagnetic signals, optical signals or any suitable combination of the above. The computer-readable signal medium may also be any computer-readable medium other than the computer-readable storage medium, and may send, propagate or transmit a program used by or in combination with an instruction execution system, apparatus or device. The program codes contained in the computer-readable medium may be transmitted by any suitable medium, including but not limited to: electric wires, optical cables, radio frequency (RF) and the like, or any suitable combination of the above.

In some implementations, the client and the server can communicate by using any currently known or future developed network protocol such as a hypertext transfer protocol (HTTP), and may be interconnected with digital data communication in any form or medium (for example, a communication network). Examples of the communication network include a local area network (LAN), a wide area network (WAN), the Internet work (for example, the Internet) and an end-to-end network (for example, an ad hoc end-to-end network), as well as any currently known or future developed networks.

The computer-readable medium may be included in the electronic device; or it may exist alone without being assembled into the electronic device.

The computer-readable medium carries one or more programs which, when executed by the electronic device, cause the electronic device to: display a first trailing picture of an effect object at a first motion frame when the effect object is in a motion state, where the effect object is a selected object to which a trailing effect is applied;
capture a second motion frame of the effect object at a set frame rate;
determine a second trailing picture of the effect object at the second motion frame through the first trailing picture; and
display the second trailing picture.

Computer program codes for performing the operations of the present disclosure may be written in one or more programming languages or combinations thereof, including but not limited to object-oriented programming languages such as Java, Smalltalk and C++, and conventional procedural programming languages such as “C” or similar programming languages. The program codes may be completely executed on a user computer, partially executed on the user computer, executed as an independent software package, partially executed on the user computer and partially executed on a remote computer, or completely executed on the remote computer or a server. In the case involving the remote computer, the remote computer may be connected to the user computer through any type of network, including a local area network (LAN) or a wide area network (WAN), or may be connected to an external computer (for example, through the Internet using an Internet service provider).

The flowchart and block diagrams in the drawings illustrate architectures, functions and operations of possible implementations of the systems, methods and the computer program product according to various embodiments of the present disclosure. In this regard, each block in the flowchart or block diagram may represent a part of a module, a program segment, or codes, which includes one or more executable instructions for implementing specified logical functions. It is also noted that, in some alternative implementations, the functions noted in the block may occur out of the order noted in the figures. For example, two blocks shown in succession may, in fact, be executed substantially in parallel, and may sometimes be executed in the reverse order, depending on the functions involved. It is also noted that each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The units involved in the embodiments described in the present disclosure may be implemented by software or hardware. The name of the unit does not constitute a limitation on the unit itself in some cases. For example, a first acquisition unit can also be described as “a unit that acquires at least two Internet protocol addresses”.

The functions described above herein may be at least partially performed by one or more hardware logic components. For example, without limitation, exemplary types of hardware logic components that may be used include: a field programmable gate array (FPGA), an application-specific integrated circuit (ASIC), an application specific standard product (ASSP), a system-on-chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, Example 1 provides an effect display method, including:
displaying a first trailing picture of an effect object at a first motion frame when the effect object is in a motion state, where the effect object is a selected object to which a trailing effect is applied;
capturing a second motion frame of the effect object at a set frame rate;
determining a second trailing picture of the effect object at the second motion frame through the first trailing picture; and
displaying the second trailing picture.

According to one or more embodiments of the present disclosure, Example 2 provides an effect display method, including:
optionally, after displaying the second trailing picture, the method further includes:
taking the second motion frame as a new first motion frame and the second trailing picture as a new first trailing picture, and returning to continue a capturing operation for obtaining a second motion frame.

According to one or more embodiments of the present disclosure, Example 3 provides an effect display method, including:
optionally, when the first motion frame is an initial motion frame, the step of determining the first trailing picture includes:
acquiring first display attribute information of the effect object after rendered in the initial motion frame;
generating a first attribute texture map of the effect object as a first trailing intensity texture map based on the first display attribute information; and
coloring the first trailing intensity texture map to obtain the first trailing picture of the effect object.

According to one or more embodiments of the present disclosure, Example 4 provides an effect display method, including:
optionally, the determining a second trailing picture of the effect object at the second motion frame through the first trailing picture includes:
extracting a first trailing intensity texture map constituting the first trailing picture;
forming a second trailing intensity texture map of the effect object at the second motion frame according to the first trailing intensity texture map and an attenuation factor that is determined; and
coloring the second trailing intensity texture map to obtain a second trailing picture of the effect object at the second motion frame.

According to one or more embodiments of the present disclosure, Example 5 provides an effect display method, including:
optionally, the attenuation factor is a set constant; or, the attenuation factor is determined according to a duration for which the effect object has moved in the motion state.

According to one or more embodiments of the present disclosure, Example 6 provides an effect display method, including:
optionally, the forming a second trailing intensity texture map of the effect object at the second motion frame according to the first trailing intensity texture map and a determined attenuation factor includes:
obtaining a trailing attenuation texture map based on the first trailing intensity texture map and the attenuation factor corresponding to the second motion frame;
obtaining a second motion picture frame of the effect object at the second motion frame; and
forming a second trailing intensity texture map of the effect object at the second motion frame according to the second motion picture frame and the trailing attenuation texture map.

According to one or more embodiments of the present disclosure, Example 7 provides an effect display method, including:
optionally, the obtaining a trailing attenuation texture map based on the first trailing intensity texture map and the attenuation factor corresponding to the second motion frame includes:
obtaining a corresponding target attenuation factor at the second motion frame; and
multiplying a first trailing intensity value of each pixel point in the first trailing intensity texture map and the target attenuation factor to obtain the trailing attenuation texture map.

According to one or more embodiments of the present disclosure, Example 8 provides an effect display method, including:
optionally, the forming a second trailing intensity texture map of the effect object at the second motion frame according to the second motion picture frame and the trailing attenuation texture map includes:
obtaining a second attribute texture map, relative to a set display attribute, of the effect object at the second motion picture frame;
performing a merge process on the second attribute texture map and the trailing attenuation texture map; and
taking a merged texture map as the second trailing intensity texture map of the effect object at the second motion frame.

According to one or more embodiments of the present disclosure, Example 9 provides an effect display method, including:
optionally, the coloring the second trailing intensity texture map to obtain a second trailing picture of the effect object at the second motion frame includes:
obtaining a second trailing intensity value of each pixel point in the second trailing intensity texture map;
determining a color data value corresponding to the second trailing intensity value according to a preset corresponding relationship between intensity values and colors; and
coloring the pixel point with the color data value to obtain the second trailing picture of the effect object at the second motion frame.

According to one or more embodiments of the present disclosure, Example 10 provides an effect display apparatus, including:
a first display module, configured to display a first trailing picture of an effect object at a first motion frame when the effect object is in a motion state, where the effect object is a selected object to which a trailing effect is applied;
a motion frame capturing module, configured to capture a second motion frame of the effect object at a set frame rate;
a picture determination module, configured to determine a second trailing picture of the effect object at the second motion frame through the first trailing picture; and
a second display module, configured to display the second trailing picture.

The foregoing descriptions are merely the illustrations of the alternative embodiments of the present disclosure and the explanations of the technical principles involved. Those skilled in the art should understand that the scope of the disclosure involved in the present disclosure is not limited to the technical solutions formed by a specific combination of the technical features described above, and shall also cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated particular order or in a sequential order. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be implemented in a combination in a single embodiment. Conversely, various features described in the context of a single embodiment may also be implemented in various embodiments individually or in a plurality of embodiments in any appropriate sub-combination.

Although the present subject matter has been described in a language specific to structural features and/or logical method acts, it will be appreciated that the subject matter defined in the appended claims is not necessarily limited to the particular features or acts described above. Rather, the particular features and acts described above are merely exemplary forms for implementing the claims.

1. An effect display method, comprising:
displaying a first trailing picture of an effect object at a first motion frame when the effect object is in a motion state, wherein the effect object is a selected object to which a trailing effect is applied;
capturing a second motion frame of the effect object at a set frame rate;
determining a second trailing picture of the effect object at the second motion frame through the first trailing picture; and
displaying the second trailing picture.

2. The method according to claim 1, wherein after the displaying the second trailing picture, the method further comprises:
taking the second motion frame as a new first motion frame and taking the second trailing picture as a new first trailing picture, and returning to continue performing a capturing operation for obtaining a new second motion frame.

3. The method according to claim 1, wherein when the first motion frame is an initial motion frame, a step of determining the first trailing picture comprises:
acquiring first display attribute information of the effect object after rendered in the initial motion frame;
generating, based on the first display attribute information, a first attribute texture map of the effect object as a first trailing intensity texture map; and
coloring the first trailing intensity texture map to obtain the first trailing picture of the effect object.

4. The method according to claim 1, wherein the determining a second trailing picture of the effect object at the second motion frame through the first trailing picture comprises:
extracting a first trailing intensity texture map constituting the first trailing picture;
forming a second trailing intensity texture map of the effect object at the second motion frame according to the first trailing intensity texture map and an attenuation factor that is determined; and
coloring the second trailing intensity texture map to obtain the second trailing picture of the effect object at the second motion frame.

5. The method according to claim 4, wherein the attenuation factor is a set value;
or, the attenuation factor is determined according to a duration for which the effect object has moved in the motion state.

6. The method according to claim 4, wherein the forming a second trailing intensity texture map of the effect object at the second motion frame according to the first trailing intensity texture map and a determined attenuation factor comprises:
obtaining a trailing attenuation texture map based on the first trailing intensity texture map and the attenuation factor corresponding to the second motion frame;
obtaining a second motion picture frame of the effect object at the second motion frame; and
forming the second trailing intensity texture map of the effect object at the second motion frame according to the second motion picture frame and the trailing attenuation texture map.

7. The method according to claim 6, wherein the obtaining a trailing attenuation texture map based on the first trailing intensity texture map and the attenuation factor corresponding to the second motion frame comprises:
obtaining a target attenuation factor corresponding to the second motion frame; and
multiplying a first trailing intensity value of each pixel point in the first trailing intensity texture map and the target attenuation factor to obtain the trailing attenuation texture map.

8. The method according to claim 6, wherein the forming the second trailing intensity texture map of the effect object at the second motion frame according to the second motion picture frame and the trailing attenuation texture map comprises:
obtaining a second attribute texture map, relative to a set display attribute, of the effect object at the second motion picture frame;
performing a merge process on the second attribute texture map and the trailing attenuation texture map; and
taking a merged texture map as the second trailing intensity texture map of the effect object at the second motion frame.

9. The method according to claim 4, wherein the coloring the second trailing intensity texture map to obtain the second trailing picture of the effect object at the second motion frame comprises:
obtaining a second trailing intensity value of each pixel point in the second trailing intensity texture map;
determining a color data value corresponding to the second trailing intensity value according to a preset corresponding relationship between intensity value and color; and
coloring the pixel point with the color data value to obtain the second trailing picture of the effect object at the second motion frame.

10. (canceled)

11. An electronic device, comprising:
one or more processors; and
a storage apparatus, configured to store one or more programs, wherein, the one or more programs, when executed by the one or more processors, cause the one or more processors to implement an effect display method, and the method comprises:
displaying a first trailing picture of an effect object at a first motion frame when the effect object is in a motion state, wherein the effect object is a selected object to which a trailing effect is applied;
capturing a second motion frame of the effect object at a set frame rate;
determining a second trailing picture of the effect object at the second motion frame through the first trailing picture; and
displaying the second trailing picture.

12. A non-transitory computer-readable storage medium, wherein the non-transitory computer-readable storage medium stores computer programs, when the computer programs are executed by a processor, an effect display method is implemented, and the method comprises:
displaying a first trailing picture of an effect object at a first motion frame when the effect object is in a motion state, wherein the effect object is a selected object to which a trailing effect is applied;
capturing a second motion frame of the effect object at a set frame rate;
determining a second trailing picture of the effect object at the second motion frame through the first trailing picture; and
displaying the second trailing picture.

13. The electronic device according to claim 11, wherein after the displaying the second trailing picture, the method further comprises:
taking the second motion frame as a new first motion frame and taking the second trailing picture as a new first trailing picture, and returning to continue performing a capturing operation for obtaining a new second motion frame.

14. The electronic device according to claim 11, wherein when the first motion frame is an initial motion frame, a step of determining the first trailing picture comprises:
acquiring first display attribute information of the effect object after rendered in the initial motion frame;
generating, based on the first display attribute information, a first attribute texture map of the effect object as a first trailing intensity texture map; and
coloring the first trailing intensity texture map to obtain the first trailing picture of the effect object.

15. The electronic device according to claim 11, wherein the determining a second trailing picture of the effect object at the second motion frame through the first trailing picture comprises:
extracting a first trailing intensity texture map constituting the first trailing picture;
forming a second trailing intensity texture map of the effect object at the second motion frame according to the first trailing intensity texture map and an attenuation factor that is determined; and
coloring the second trailing intensity texture map to obtain the second trailing picture of the effect object at the second motion frame.

16. The electronic device according to claim 15, wherein the attenuation factor is a set value; or, the attenuation factor is determined according to a duration for which the effect object has moved in the motion state.

17. The electronic device according to claim 15, wherein the forming a second trailing intensity texture map of the effect object at the second motion frame according to the first trailing intensity texture map and a determined attenuation factor comprises:
obtaining a trailing attenuation texture map based on the first trailing intensity texture map and the attenuation factor corresponding to the second motion frame;
obtaining a second motion picture frame of the effect object at the second motion frame; and
forming the second trailing intensity texture map of the effect object at the second motion frame according to the second motion picture frame and the trailing attenuation texture map.

18. The electronic device according to claim 17, wherein the obtaining a trailing attenuation texture map based on the first trailing intensity texture map and the attenuation factor corresponding to the second motion frame comprises:
obtaining a target attenuation factor corresponding to the second motion frame; and
multiplying a first trailing intensity value of each pixel point in the first trailing intensity texture map and the target attenuation factor to obtain the trailing attenuation texture map.

19. The electronic device according to claim 17, wherein the forming the second trailing intensity texture map of the effect object at the second motion frame according to the second motion picture frame and the trailing attenuation texture map comprises:
obtaining a second attribute texture map, relative to a set display attribute, of the effect object at the second motion picture frame;
performing a merge process on the second attribute texture map and the trailing attenuation texture map; and
taking a merged texture map as the second trailing intensity texture map of the effect object at the second motion frame.

20. The electronic device according to claim 15, wherein the coloring the second trailing intensity texture map to obtain the second trailing picture of the effect object at the second motion frame comprises:
obtaining a second trailing intensity value of each pixel point in the second trailing intensity texture map;
determining a color data value corresponding to the second trailing intensity value according to a preset corresponding relationship between intensity value and color; and
coloring the pixel point with the color data value to obtain the second trailing picture of the effect object at the second motion frame.

21. The method according to claim 2, wherein when the first motion frame is an initial motion frame, a step of determining the first trailing picture comprises:
acquiring first display attribute information of the effect object after rendered in the initial motion frame;
generating, based on the first display attribute information, a first attribute texture map of the effect object as a first trailing intensity texture map; and
coloring the first trailing intensity texture map to obtain the first trailing picture of the effect object.
